(19) United States
(12) Patent Application Publication
(10) Pub. No.: US 2013/0139240 A1
(43) Pub. Date: May 30, 2013

(54) NETWORK SYSTEM, INFORMATION PROCESSING APPARATUS, METHOD FOR CONTROLLING THE INFORMATION PROCESSING APPARATUS, AND COMPUTER-READABLE STORAGE MEDIUM FOR COMPUTER PROGRAM

(71) Applicants: Kazumi SAWAYANAGI, Chiyoda-ku (JP); Kazuaki Tomono, Chiyoda-ku (JP); Kenichi Takahashi, Chiyoda-ku (JP); Kenji Matsuhara, Chiyoda-ku (JP); Yosuke Taniguchi, Chiyoda-ku (JP)

(72) Inventors: Kazumi SAWAYANAGI, Chiyoda-ku (JP); Kazuaki Tomono, Chiyoda-ku (JP); Kenichi Takahashi, Chiyoda-ku (JP); Kenji Matsuhara, Chiyoda-ku (JP); Yosuke Taniguchi, Chiyoda-ku (JP)

(73) Assignee: KONICA MINOLTA BUSINESS TECHNOLOGIES, INC., Tokyo (JP)

(21) Appl. No.: 13/679,178

(22) Filed: Nov. 16, 2012

(30) Foreign Application Priority Data
Nov. 30, 2011 (JP) 2011-261272

(51) Int. Cl. G06F 21/41

(52) U.S. Cl. CPC G06F 21/41
USPC 726/8

(57) ABSTRACT

A network system including at least one client and a user account management server is provided. The user account management server includes a user account saving portion for saving a user identifier and a user password for a cooperative server with which at least one client works in coordination for specific processing. Each of the clients includes an application storage portion for storing an application for the specific processing, a reference information storage portion for storing reference information to be referred to when the application is executed, a location information obtaining portion for obtaining location information indicating a saving location of the user identifier and user password, a user account obtaining portion for obtaining, based on the location information, the user identifier and the user password from the user account management server, and an update portion for updating the reference information to indicate the user identifier and the user password.

This application is based on Japanese patent application No. 2011-261272 filed on Nov. 30, 2011, the contents of which are hereby incorporated by reference.

### BACKGROUND OF THE INVENTION

1. Field of the Invention

The present invention relates to an apparatus for performing processing based on an application in coordination with a server, a method for controlling the apparatus, and so on.

2. Description of the Related Art

Recent years have seen the widespread use of image forming apparatuses that include functions such as copying, scanning, faxing, and network printing. Such an image forming apparatus is usually called a “multifunction device” or a “Multi-Functional Peripheral” (MFP).

Further, the functionality of such an image forming apparatus is increasingly improved. To be specific, a Central Processing Unit (CPU) carries out processing faster, a hard disk space in the image forming apparatus is increased, and a resolution of a touch-sensitive panel display is improved. Along with the improvement in functionality, different types of software programs for the image forming apparatus come to be produced.

In general, when software starts up, a user thereof is often required to enter a user identifier (user ID, user code). In particular, it is sometimes necessary to identify a user using an image forming apparatus shared by a plurality of users. The user is often required to enter not only such a user identifier but a password. This is because user authentication is performed in order to prevent the software from being used illicitly. The user identifier and the password are set for each piece of software.

Further, setting a use environment (configuration) is needed for each piece of software and for each user. In other words, many matters need to be adjusted for each piece of software and for each user. Such adjustment values are associated with a user identifier of the user concerned and stored, as user information, into a database and so on.

An example of a method for easily invoking adjustment values for each user and reflecting the same is as follows.

A database in which user identification information and user information are stored corresponding to each other is prepared in an information processor. The information processor is further provided with: a specific processing execution portion for executing specific processing; an identification information obtaining portion for obtaining user identification information recorded on a recording medium; a verifying portion for verifying the user identification information obtained by the identification information obtaining portion; a user information obtaining portion for obtaining, from the database, user information corresponding to the user identification information verified by the verifying portion; and a transmission portion for sending, to the specific processing execution portion, the user information obtained by the user information obtaining portion (see Japanese Laid-open Patent Publication No. 2009-260641).

In the meantime, while some software programs are executed completely by only one image forming apparatus, other software programs need to be executed by an image forming apparatus operating in coordination with a server on the Internet.

In particular, installing the latter software program, i.e., the software program to be executed in coordination with a server on the Internet, on each of image forming apparatuses gives convenience to a user. This is because even if the user operates any of the image forming apparatus, he/she can obtain consistent service based on his/her data managed centrally by the server.

The user is, however, required to enter his/her user identifier and password every time when he/she changes image forming apparatuses from one to another for operation, which is cumbersome for the user.

### SUMMARY

The present invention has been achieved in light of such an issue, and an object thereof is to provide a technology for, when a user changes an apparatus to be operated from one to another, managing a user identifier and a password more easily than is conventionally possible.

According to an aspect of the present invention, a network system includes at least one client, and a user account management server. The user account management server includes a user account saving portion configured to save, thereto, a user identifier and a user password for a cooperative server with which at least one client works in coordination for specific processing. Each of at least one client includes an application storage portion configured to store, therein, an application for the specific processing, a reference information storage portion configured to store, therein, reference information to be referred to when the application is executed, a location information obtaining portion configured to obtain location information indicating a saving location of the user identifier and the user password, a user account obtaining portion configured to obtain, based on the location information, the user identifier and the user password from the user account management server, and an update portion configured to update the reference information in such a manner that the user identifier and the user password obtained are indicated.

According to another aspect of the present invention, an information processing apparatus for performing specific processing in coordination with a cooperative server includes an application storage portion configured to store, therein, an application for the specific processing; a reference information storage portion configured to store, therein, reference information to be referred to when the application is executed; a location information obtaining portion configured to obtain location information indicating a saving location of a user identifier and a user password for the cooperative server; a user account obtaining portion configured to obtain, based on the location information, the user identifier and the user password from the user account management server; and an update portion configured to update the reference information in such a manner that the user identifier and the user password obtained are indicated.

Preferably, the user account obtaining portion may obtain the user identifier and the user password before the application is initiated.

The location information obtaining portion may obtain the location information for the user from a local server that is installed in a network in which the information processing apparatus is located and is operable to manage a user account of the user, the location information for the user being obtained when the user logs onto the network through the information processing apparatus.

The information processing apparatus may include a saving request portion configured to, when the user reenters a user identifier and a user password, request the cooperative server to save the user identifier and the user password reentered to the saving location.

The information processing apparatus may include an update request portion configured to, when the user changes the user identifier, request the cooperative server to update an existing user identifier with the post-change user identifier, and, when the user changes the user password, request the cooperative server to update an existing user password with the post-change user password.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of the overall configuration of an intranet.

FIG. 2 is a diagram showing an example of the hardware configuration of each of a resource management server and an application information management server.

FIG. 3 is a diagram showing an example of the functional configuration of a resource management server.

FIG. 4 is a diagram showing an example of the functional configuration of an application information management server.

FIG. 5 is a diagram showing an example of the hardware configuration of an image forming apparatus.

FIG. 6 is a diagram showing an example of the functional configuration of an image forming apparatus.

FIG. 7 is a diagram showing an example of user account data.

FIG. 8 is a diagram showing an example of application identification data.

FIG. 9 is a diagram showing an example of an application selection screen.

FIG. 10 is a flowchart depicting an example of the flow of overall processing performed by application management software.

### DESCRIPTION OF THE PREFERRED EMBODIMENTS

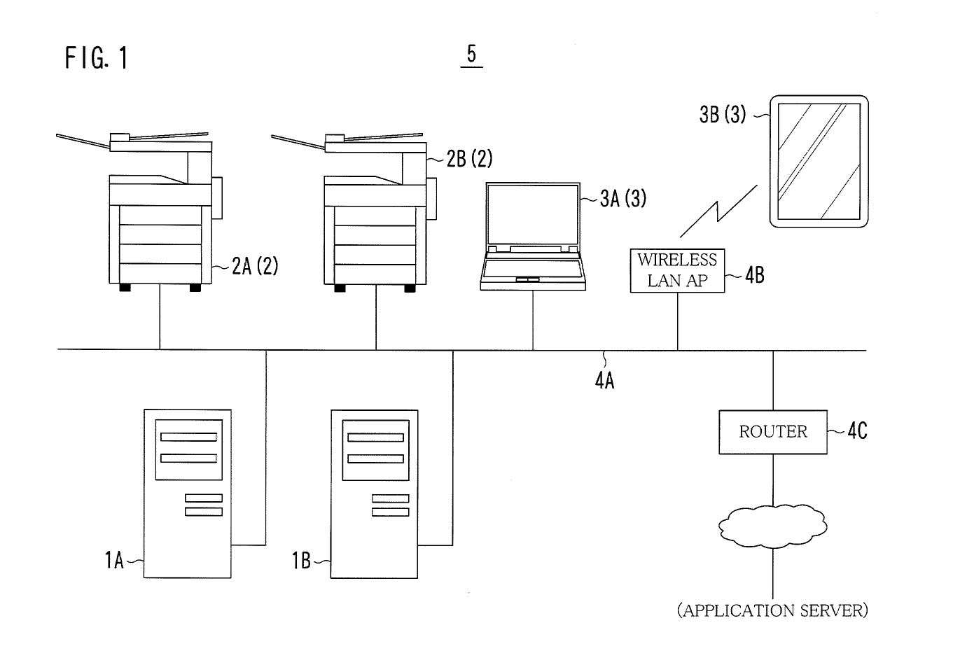

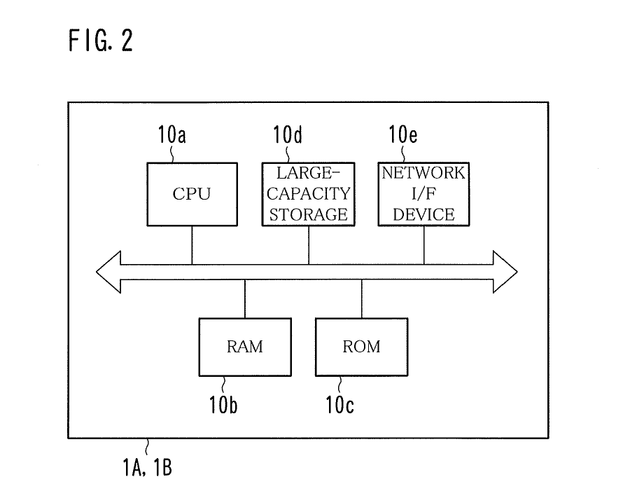

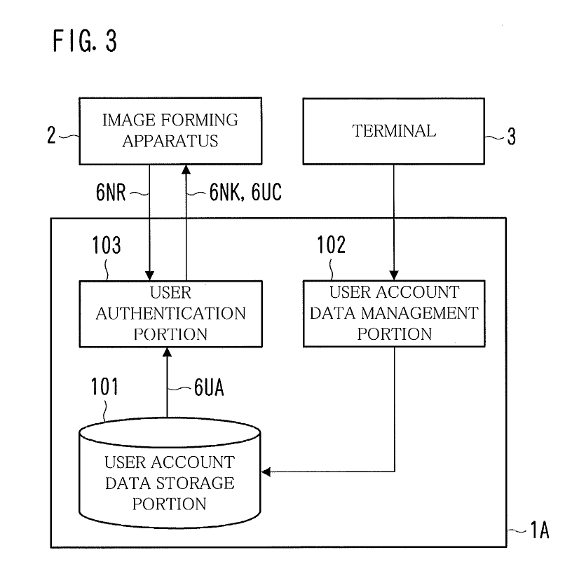

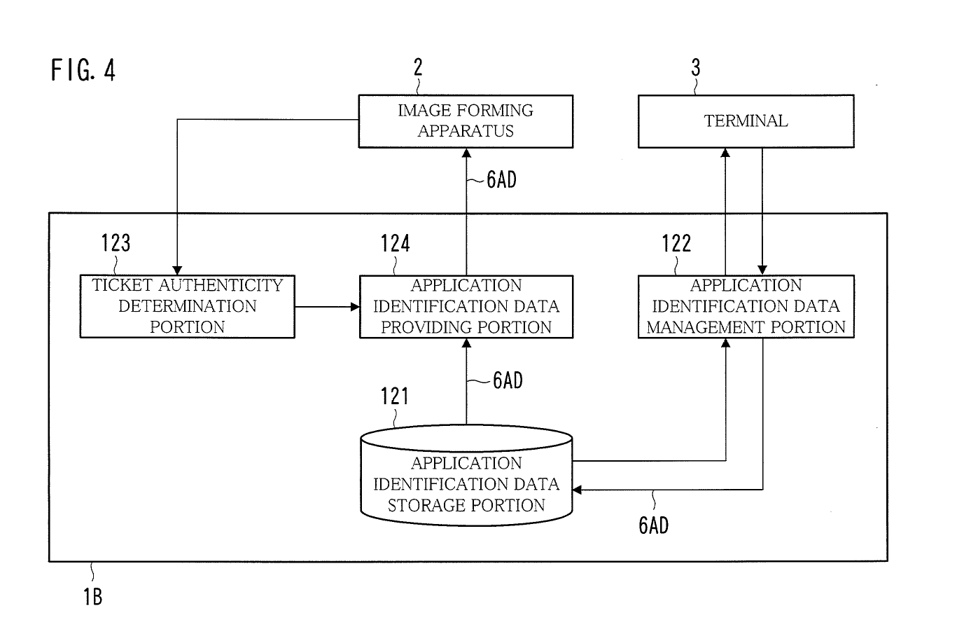

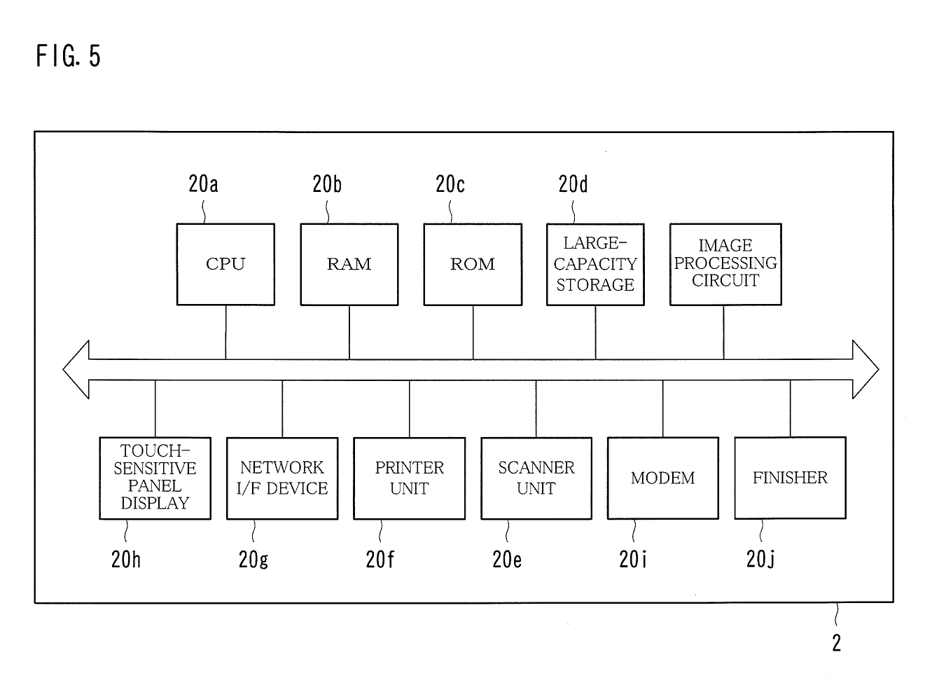

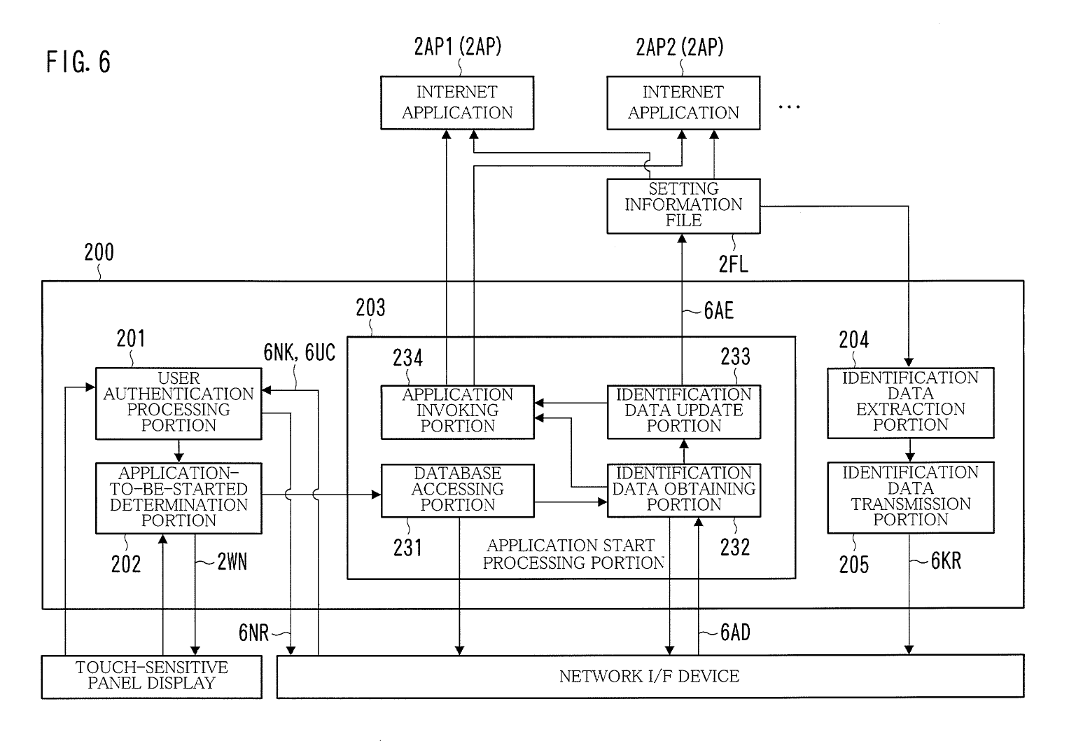

FIG. 1 is a diagram showing an example of the overall configuration of an intranet 5; FIG. 2 is a diagram showing an example of the hardware configuration of each of a resource management server 1A and an application information management server 1B; FIG. 3 is a diagram showing an example of the functional configuration of the resource management server 1A; FIG. 4 is a diagram showing an example of the functional configuration of the application information management server 1B; FIG. 5 is a diagram showing an example of the hardware configuration of an image forming apparatus 2; and FIG. 6 is a diagram showing an example of the functional configuration of the image forming apparatus 2.

Referring to FIG. 1, the intranet 5 is configured of the resource management server 1A, the application information management server 1B, a plurality of the image forming apparatuses 2, a plurality of terminals 3, a wired circuit 4A, a wireless Local Area

Network (LAN) access point 4B, a router 4C, and so on.

The intranet 5 is installed in a facility of an organization such as a public office, a corporation, and a school. Therefore, members of the organization use the individual devices connected to the intranet 5.

The wired circuit 4A is implemented by a twisted-pair cable and a hub, for example. The wired circuit 4A is used to connect the resource management server 1A, the application information management server 1B, the image forming apparatuses 2, the terminals 3, the wireless LAN access point 4B, and the router 4C to one another.

The wireless LAN access point 4B is a base station of the wireless LAN. The wireless LAN access point 4B is operable to relay communication between a device provided with a so-called wireless LAN slave unit and another device.

The router 4C serves to connect the intranet 5 to another network such as the Internet.

The resource management server 1A serves to manage, for example, resources in the intranet 5 and user accounts of users. Referring to FIG. 2, the resource management server 1A is configured of a Central Processing Unit (CPU) 10a, a Random Access Memory (RAM) 10b, a Read Only Memory (ROM) 10c, a large-capacity storage 10d, a network interface device 10e, and so on.

The ROM 10c or the large-capacity storage 10d stores, therein, software for implementing the functions of a user account data storage portion 101, a user account data management portion 102, and a user authentication portion 103, all of which are shown in FIG. 3. An example of the large-capacity storage 10d is a Hard Disk Drive (HDD) or a Solid State Drive (SSD).

Modules forming the software and data are loaded into the RAM 10b, if necessary, and are executed by the CPU 10a.

The network interface device 10e performs communication with other devices of the intranet 5 and devices on the Internet according to Transmission Control Protocol/Internet Protocol (TCP/IP). An example of the network interface device 10e is a Network Interface Card (NIC) or a wireless LAN slave unit.

The application information management server 1B is a server for managing information on settings of user accounts for applications installed on the image forming apparatuses 2 and the terminals 3.

The hardware configuration of the application information management server 1B is similar to that of the resource management server 1A shown in FIG. 2. However, the difference therebetween is that the ROM 10c and the large-capacity storage 10d of the application information management server 1B store, therein, software for implementing the functions of an application identification data storage portion 121, an application identification data management portion 122, a ticket authenticity determination portion 123, and an application identification data providing portion 124, all of which are shown in FIG. 4.

The image forming apparatus 2 is an image processing apparatus that is generally called a “multifunction device” or a “Multi-Functional Peripheral (MFP)”. The image forming apparatus 2 is an apparatus in which functions such as copying, network printing, faxing, and scanning are consolidated. The image forming apparatus 2 is also equipped with a function to connect to the Internet.

As shown in FIG. 5, the image forming apparatus 2 is configured of a CPU 20a, a RAM 20b, a ROM 20c, a large-capacity storage 20d, a scanner unit 20e, a printer unit 20f, a network interface device 20g, a touch-sensitive panel display 20h, a modem 20i, a finisher 20j, an image processing circuit, and so on.

The network interface device 20g performs communication with other devices of the intranet 5 and devices on the Internet according to TCP/IP. An example of the network interface device 20g is an NIC or a wireless LAN slave unit.

The touch-sensitive panel display 20h serves to display, for example, a screen for presenting messages or instructions to a user, a screen for allowing a user to input processing commands and conditions, and a screen showing the results of processing performed by the CPU 20a. The touch-sensitive panel display 20h also detects a position touched by user's finger, and transmits a signal indicating the detection result to the CPU 20a.

The scanner unit 20e serves to optically read an image such as photographs, characters, pictures, charts, and the like that are recorded on a sheet of paper, and to generate image data thereof.

The modem 20i is a device to send and receive image data, based on a protocol such as G3, with other fax terminals.

The printer unit 20f prints, onto paper, an image read by the scanner unit 20e and an image indicated in data sent by the terminals 3 or a fax terminal.

The finisher 20j serves to apply a finish to a printed matter onto which the printer unit 20f has printed an image. The finisher 20j performs, for example, a process for stapling such a printed matter, and a process for punching a hole therein.

The ROM 20c or the large-capacity storage 20d has installed therein software such as an operating system and middleware.

The image forming apparatus 2 has different applications installed therein. In particular, the image forming apparatus 2 according to this embodiment has installed therein an application for performing processing in coordination with a server on the Internet.

Examples of such an application are: an application for document management on the Internet, e.g., Evernote (registered trademark) provided by Evernote Corporation; an application for a user to join Social Networking Service (SNS), e.g., Facebook (registered trademark) provided by Facebook Inc.; and an application for a user to send short text-based messages created by himself/herself and to read short text-based messages created by another user, e.g., Twitter (registered trademark) provided by Twitter, Inc. These applications are usually called Software as a Service (Saas). A server to provide such service is usually called a SaaS server.

These applications enable the image forming apparatus 2 to function as a client for obtaining service provided by a SaaS server on the Internet.

In general, every time a user starts such an application, he/she is required to provide the server with his/her user identifier and password for user authentication. Hereinafter, these applications are referred to as “Internet applications 2AP”. Further, the Internet applications 2AP may be described separately as an “Internet application 2AP1”, an “Internet application 2AP2”, . . . and so on.

Each of the Internet applications 2AP (2AP1, 2AP2, . . . ) is a version compatible with the image forming apparatus 2. Another version is also distributed which is provided with functions equal to those of each of the Internet applications 2AP and compatible with a platform of the terminal 3 (personal computer or a smartphone). Accordingly, a user can obtain service provided by one identical server either through the image forming apparatus 2 or the terminal 3. When the user uses the image forming apparatus 2 or the terminal 3, it is preferable that the user basically enters his/her user identifier and password into the image forming apparatus 2 or the terminal 3 to be used every time he/she starts such an application.

In order to handle user identifiers and passwords more easily than is conventionally possible at the time of using the applications, the image forming apparatus 2 also stores application management software 200 therein. The application management software 200 is provided to the image forming apparatus 2 as middleware.

The application management software 200 implements the functions of a user authentication processing portion 201, an application-to-be-started determination portion 202, an application start processing portion 203, an identification data extraction portion 204, an identification data transmission portion 205, all of which are shown in FIG. 6. Some of the functions can be implemented by the application management software 200 working in coordination with the operating system.

Modules forming the software and data are loaded into the RAM 20b, if necessary, and are executed by the CPU 20a. An example of the large-capacity storage 20d is an HDD or an SSD.

Hereinafter, the image forming apparatuses 2 are sometimes distinguished from one another as an “image forming apparatus 2A”, an “image forming apparatus 2B”, and so on.

The terminal 3 is a client used for a user to obtain service provided by the image forming apparatus 2 or a server on the Internet. An example of the terminal 3 is a personal computer, a smartphone, a mobile phone terminal, a tablet PC, or a Personal Digital Assistant (PDA). Hereinafter, the terminals 3 are sometimes distinguished from one another as a “terminal 3A”, a “terminal 3B”, and so on. The terminal 3A is a personal computer and is provided with an NIC functioning as a network interface device. The terminal 3B is a tablet PC and is provided with a wireless LAN device functioning as the network interface device.

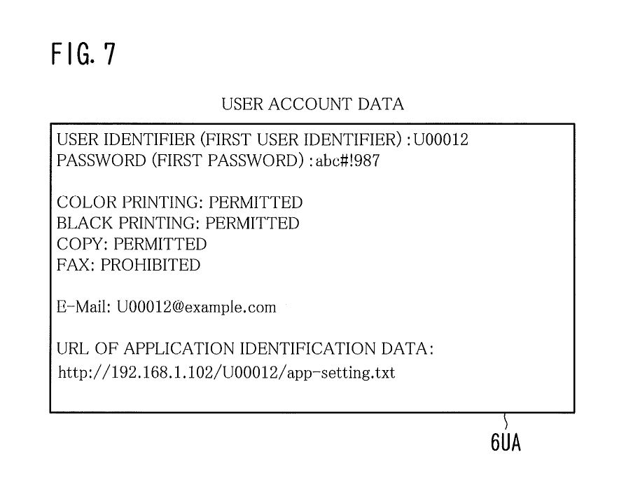

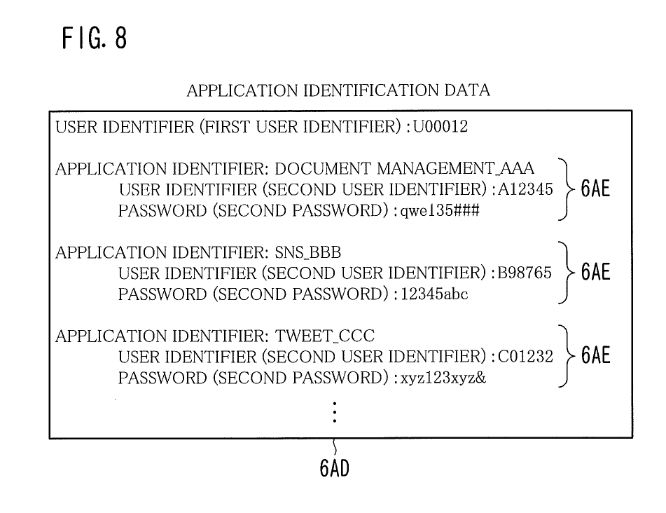

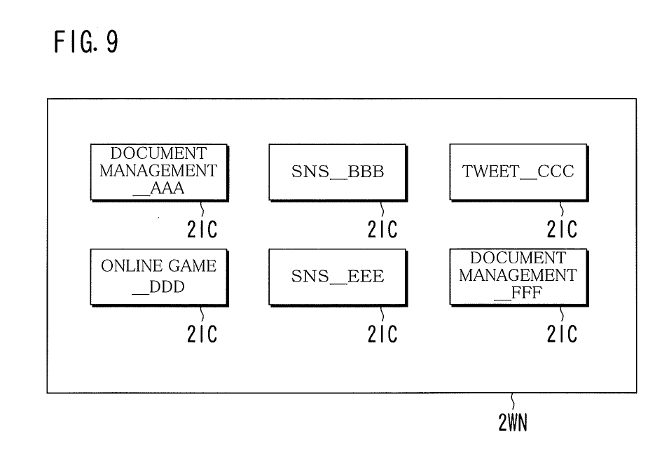

FIG. 7 is a diagram showing an example of user account data 6UA; FIG. 8 is a diagram showing an example of application identification data 6AD; and FIG. 9 is a diagram showing an example of an application selection screen 2WN.

Descriptions are provided below of the functions of the individual portions of the resource management server 1A, the application information management server 1B, and the image forming apparatus 2, and of the processing by the individual portions thereof.

The user account data 6UA is assigned to each user. The user account data storage portion 101 (see FIG. 3) of the resource management server 1A stores, therein, the user account data 6UA for each user.

As shown in FIG. 7, the user account data 6UA indicates a first user identifier and a first password of the user to whom the user account data 6UA is given. The user account data 6UA also indicates, for example, functions of the image forming apparatus 2 and access right conditions of the options for the user concerned, and an electronic mail address of the user concerned. The first user identifier and the first password are used for user authentication processing performed when the user concerned attempts to log onto the intranet 5.

The user account data 6UA also indicates a storage location of the application identification data 6AD of the user concerned. The following description takes the example of the case where the storage location is indicated in the form of Uniform Resource Locator (URL).

The application identification data 6AD indicates information on settings made for each Internet application 2AP. To be specific, the application identification data 6AD contains application-specific data 6AE for each Internet application 2AP as shown in FIG. 8. The application-specific data 6AE indicates an application identifier of the Internet application 2AP, a second user identifier and a second password of the user concerned. The second user identifier and the second password are a user identifier and a password to be used for the user to log onto a server working in coordination with the corresponding Internet application 2AP. Further, the application identification data 6AD indicates the first user identifier of the user concerned. The application identification data 6AD is stored in the application identification data storage portion 121 (see FIG. 4) of the application information management server 1B.

The user account data management portion 102 performs processing for managing the user account data 6UA. To be specific, the user account data management portion 102 performs: processing for storing user account data 6UA of a new user into the user account data storage portion 101; processing for deleting user account data 6UA of a user who left the organization from the user account data storage portion 101; and processing for rewriting the content of the existing user account data 6UA. The user account data management portion 102 performs such processing in accordance with instructions given by an administrator of the intranet 5. The instructions are inputted to the terminal 3, and then, sent to the resource management server 1A.

When user account data 6UA of a new user is stored into the user account data storage portion 101, the administrator prepares application identification data 6AD for the new user in the application information management server 1B. At this time, the administrator gives predetermined instructions to the application information management server 1B. In response to this operation, the application identification data management portion 122 (see FIG. 4) of the application information management server 1B performs the following processing.

When receiving the predetermined instructions, the application identification data management portion 122 generates a new directory (folder) for the new user in the application identification data storage portion 121. The application identification data management portion 122 further generates new application identification data 6AD and saves the same to the new directory. The application identification data management portion 122 informs the terminal 3 operated by the administrator of an URL of the application identification data 6AD.

When being informed, the administrator edits the user account data 6UA in such a manner that the URL thus informed is indicated therein, and stores the resultant into the user account data storage portion 101. Meanwhile, the application identification data 6AD indicates information on the Internet application 2AP as discussed above; however, indicates nothing at the time when the application identification data 6AD is generated. A method for updating the application identification data 6AD is described later.

The user authentication portion 103 (see FIG. 3) of the resource management server 1A performs user authentication by checking the user identifier and the password sent from the image forming apparatus 2 and so on against the first user identifier and the first password indicated in the user account data 6UA stored in the user account data storage portion 101. To be specific, if the user account data storage portion 101 stores, therein, user account data 6UA indicating the first user identifier and the first password that match the user identifier and the password sent from the image forming apparatus 2 and so on, then the user authentication portion 103 determines that the user concerned is an authorized user. Otherwise, the user authentication portion 103 determines that the user concerned is not an authorized user. The user authentication portion 103 sends authentication result data 6NK showing the result of the determination to the device from which the user identifier and the password were sent.

The resource management server 1A may be a server providing known directory service. For example, the resource management server 1A may be an Active Directory server provided by Microsoft Corporation.

The user authentication processing portion 201 (see FIG. 6) of the image forming apparatus 2 executes processing for performing user authentication on a user who intends to log onto the intranet 5 in the following manner.

The user authentication processing portion 201 displays a screen used for the user to enter his/her user identifier and password on the touch-sensitive panel display 20h. The user uses the screen to enter his/her first user identifier and first password into the image forming apparatus 2.

In response to this operation, the user authentication processing portion 201 sends, to the resource management server 1A, authentication request data 6NR showing the first user identifier and first password entered by the user. In the resource management server 1A, the user authentication portion 103 (see FIG. 3) performs user authentication in the foregoing manner, and sends authentication result data 6NK showing the result of the user authentication to the image forming apparatus 2. When determining that the user is an authorized user, then the user authentication portion 103 extracts, from the user account data 6UA for the user, user customize data 6UC indicating access right conditions and the URL of the application identification data 6AD, and sends the user customize data 6UC to the image forming apparatus 2.

If the authentication result data 6NK indicates that the user concerned is an authorized user, then the user authentication processing portion 201 permits the user to log onto the intranet 5. In contrast, if the authentication result data 6NK indicates that the user concerned is not an authorized user, then the user authentication processing portion 201 denies the user to log onto the intranet 5.

The user who successfully logged onto the intranet 5 is allowed to use the Internet application 2AP within the access right conditions indicated in the user customize data 6UC until the user logs out of the intranet 5.

The application-to-be-started determination portion 202 determines an Internet application 2AP to be initiated, for example, in the following manner.

As shown in FIG. 9, the application-to-be-started determination portion 202 displays, on the touch-sensitive panel display 20h, the application selection screen 2WN for presenting icons 2IC for the individual

Internet applications 2AP that are installed on the ROM 20c or the large-capacity storage 20d.

The user touches the icon 2IC for the desired Internet application 2AP on the application selection screen 2WN. In response to this operation, a signal indicating the touched position is delivered from the touch-sensitive panel display 20h to the CPU 20a.

The application-to-be-started determination portion 202 checks which icon 2IC has been touched based on the signal. The application-to-be-started determination portion 202 then determines that the Internet application 2AP corresponding to the determined icon 2IC is to be initiated. Hereinafter, the Internet application 2AP that has been determined to be initiated is referred to as a “start-up target application 2APk”.

The application start processing portion 203 is configured of a database accessing portion 231, an identification data obtaining portion 232, an identification data update portion 233, an application invoking portion 234, and so on. The application start processing portion 203 performs processing for initiating a start-up target application 2APk in the following manner.

The database accessing portion 231 accesses a database for the application identification data 6AD, i.e., the application information management server 1B. The user customize data 6UC indicates a URL of the application identification data 6AD, i.e., the name (host name) of a server in which the application identification data 6AD is saved, and the path name. The database accessing portion 231 accesses the application information management server 1B based on the URL.

The identification data obtaining portion 232 downloads, from the application information management server 1B, the application identification data 6AD based on the path name and a scheme name indicated in the URL. In order to ensure the security, the following arrangement is also possible. To be specific, the identification data obtaining portion 232 sends data indicating a specific keyword, namely, an authentication ticket, to the application information management server 1B. When receiving the authentication ticket, the application information management server 1B attempts to perform authentication of the image forming apparatus 2 based on the authentication ticket. If the image forming apparatus 2 is successfully authenticated, then the application identification data 6AD may be sent.

Meanwhile, if the logged-in user has never used the start-up target application 2APk, information thereon has not yet been set up in the application identification data 6AD.

Depending on whether or not information on the start-up target application 2APk is set up in the application identification data 6AD, the identification data update portion 233, the application invoking portion 234, the identification data extraction portion 204, the identification data transmission portion 205, and the individual portions of the application information management server 1B perform the processing (1) or (2) discussed below.

(Case 1) Case where information on the start-up target application 2APk is not set up

Case 1 corresponds to a case where the application identification data 6AD does not contain the application-specific data 6AE indicating the application identifier of the start-up target application 2APk.

In such a case, the processing by the identification data update portion 233 is not performed. The application invoking portion 234 initiates the start-up target application 2APk by informing the operating system of the application identifier of the start-up target application 2APk or other operation.

In the meantime, since the Internet application 2AP performs processing in coordination with a server on the Internet as discussed above, it is necessary to send, to the server, a user identifier and a password for user authentication.

In general, when information on application settings such as a user identifier and a password is entered into the image forming apparatus 2, the information is written into a predetermined file. Hereinafter, the predetermined file is referred to as a “setting information file 2FL”. What kind of file is used as the setting information file 2FL depends on the form of the operating system.

For example, if an operating system having a form in which the large-capacity storage 20d has a directory for each application and the directory contains a so-called INI file is used, then the INI file corresponds to the setting information file 2FL. In view of this, information on application settings is written into a setting information file 2FL contained in a directory for the application.

If an operating system having a form in which information on application settings is collectively managed in one file (file such as a registry of Windows (registered trademark), for example) is used, then the file is used as the setting information file 2FL and is shared by a plurality of applications. In such a case, information on application settings is associated with an application identifier of the application and the resultant is written into the setting information file 2FL.

After the start-up target application 2APk is initiated, the image forming apparatus 2 performs the processing described below, as per the conventional art, based on the individual modules configuring the start-up target application 2APk. When information on settings is not shown in the setting information file 2FL, the image forming apparatus 2 displays a screen for the user to enter his/her user identifier and password for the start-up target application 2APk. The user enters his/her user identifier and password on the screen.

Upon the entry by the user, the image forming apparatus 2 accesses a server for the start-up target application 2APk on the Internet. The image forming apparatus 2 sends the user identifier and password entered by the user to the server and requests the same to perform user authentication.

The server performs the user authentication based on the user identifier and password sent by the image forming apparatus 2. If the user is successfully authenticated, then the user is permitted to use service of the start-up target application 2APk.

The user identifier and password entered by the user is also written into the setting information file 2FL depending on the form of the operating system as discussed above.

The identification data extraction portion 204 extracts, from the setting information file 2FL, the user identifier and the password for the start-up target application 2APk.

The identification data transmission portion 205 sends update request data 6KR to the application information management server 1B. The update request data 6KR indicates the user identifier and the password extracted by the identification data extraction portion 204, the application identifier of the start-up target application 2APk, and an URL of the application identification data 6AD obtained by the identification data obtaining portion 232.

With the application information management server 1B, when the update request data 6KR is received, the application identification data management portion 122 (see FIG. 4) updates the application identification data 6AD (see FIG. 8) in the following manner.

To be specific, the application identification data management portion 122 searches for application identification data 6AD saved in a directory identified by the URL indicated in the update request data 6KR. The application identification data management portion 122 further searches, in the application identification data 6AD, for application-specific data 6AE indicating the application identifier contained in the update request data 6KR.

If such application-specific data 6AE is found out by the search, then the application identification data management portion 122 updates the application-specific data 6AE in such a manner that the user identifier and the password indicated in the update request data 6KR are shown as the second identifier and the second password. On the other hand, if such application-specific data 6AE is not found out by the search, then new application-specific data 6AE is generated and is added to the application identification data 6AD. The application-specific data 6AE shows the application identifier indicated in the update request data 6KR. The application-specific data 6AE also shows the user identifier and the password indicated in the update request data 6KR as the second user identifier and the second password, respectively.

(Case 2) Case where information on the start-up target application 2APk is preset

Case 2 corresponds to a case where the application identification data 6AD contains the application-specific data 6AE indicating the application identifier of the start-up target application 2APk.

In such a case, the identification data update portion 233 reflects, in the setting information file 2FL, the second identifier and the second password contained in the application-specific data 6AE in the following manner.

The identification data update portion 233 writes the second identifier and the second password indicated in the application-specific data 6AE on the setting information file 2FL stored in the directory of the start-up target application 2APk. When the second user identifier and the second password are already indicated in the setting information file 2FL, the identification data update portion 233 deletes the second user identifier and the second password currently indicated, and instead, writes the second identifier and the second password contained in the application-specific data 6AE into the setting information file 2FL. In short, the identification data update portion 233 performs overwriting processing.

Alternatively, when the setting information file 2FL is shared by a plurality of applications, the identification data update portion 233 associates the second identifier and the second password indicated in the application-specific data 6AE with the start-up target application 2APk, and writes the resultant into the setting information file 2FL. When the second user identifier and the second password for the start-up target application 2APk are already indicated in the setting information file 2FL, the identification data update portion 233 deletes the second user identifier and the second password currently indicated, and instead, writes the second identifier and the second password indicated in the application-specific data 6AE into the setting information file 2FL.

When the update processing by the identification data update portion 233 is finished, the application invoking portion 234 initiates the start-up target application 2APk as with the foregoing Case 1. Thereafter, the start-up target application 2APk starts up as per the conventional art. Then, operation for logging onto the server is performed by using the second user identifier and the second password obtained from the application information management server 1B.

Note that, when the second user identifier or the second password for the start-up target application 2APk is changed to another one after the start-up target application 2APk starts up, the setting information file 2FL is changed to indicate the post-change second user identifier or the post-change second password. This is the same as that of the conventional art.

In response to this operation, as with the foregoing Case 1, the identification data extraction portion 204 and the identification data transmission portion 205 send, to the application information management server 1B, the update request data 6KR indicating the post-change second user identifier or the post-change second password. Upon the receipt of the update request data 6KR, the application identification data management portion 122 (see FIG. 4) of the application information management server 1B updates the application identification data 6AD based on the update request data 6KR.

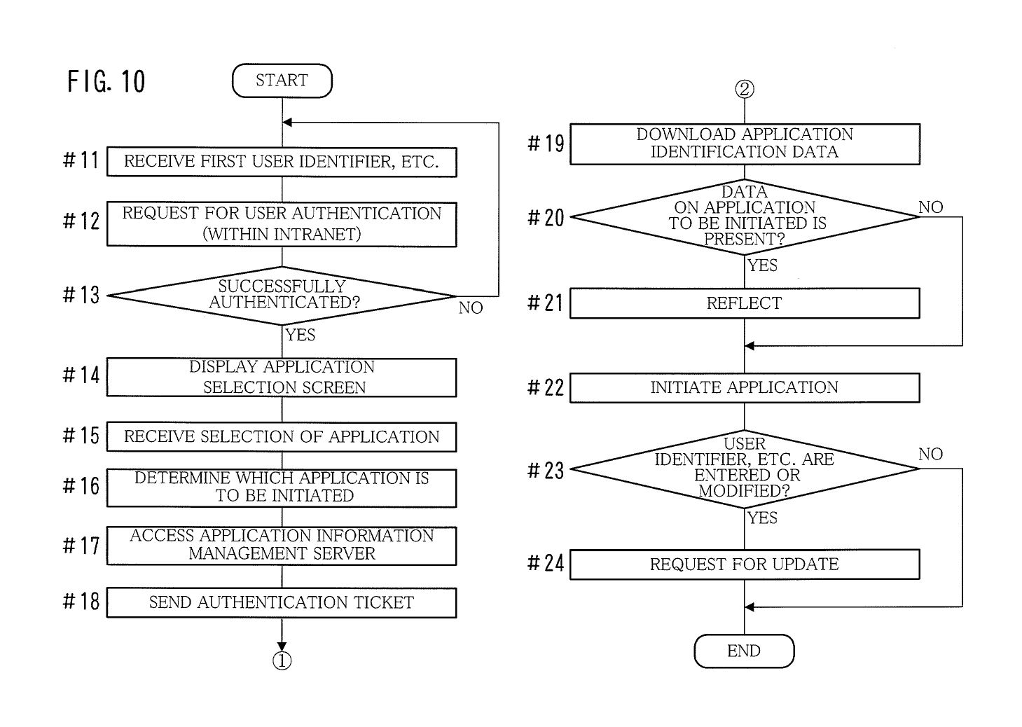

FIG. 10 is a flowchart depicting an example of the flow of overall processing performed by the application management software 200.

Descriptions are provided below of the entire processing flow performed by the application management software 200. The descriptions are given by taking an example in which a certain user Ux operates the image forming apparatus 2A to use the Internet application 2AP1.

The user Ux enters his/her first user identifier and first password into the image forming apparatus 2A in order to log onto the intranet 5.

When receiving the first user identifier and the first password (Step #11 of FIG. 10), the image forming apparatus 2A requests the resource management server 1A to perform user authentication (Step #12) by sending authentication request data 6NR indicating the first user identifier and the first password to the resource management server 1A.

When receiving, in return for the authentication request data 6NR, data indicating that the user Ux is an authorized user, and also receiving user account data 6UA (see FIG. 7) of the user Ux (Yes in Step #13), the image forming apparatus 2A displays the application selection screen 2WN (Step #14). When the user Ux selects an icon 2IC for the Internet application 2AP1 on the application selection screen 2WN, the image forming apparatus 2A receives the selection (Step #15), and determines which Internet application 2AP (start-up target application 2APk) is to be initiated (Step #16). In this example, it is determined that the Internet application 2AP1 is the start-up target application 2APk.

The image forming apparatus 2A then accesses the application information management server 1B (Step #17), and downloads the application identification data 6AD (see FIG. 8) of the user Ux (Step #19). It is preferable that, before the download, an authentication ticket is sent to the application information management server 1B or the like to obtain authentication (Step #18).

If the application identification data 6AD contains application-specific data 6AE for the Internet application 2AP1 (Yes in Step #20), then the image forming apparatus 2A writes the second user identifier and the second password indicated in the application-specific data 6AE into the setting information file 2FL used by the Internet application 2AP1 (Step #21). Otherwise (No in Step #20), the image forming apparatus 2A bypasses the processing in Step #21.

The image forming apparatus 2A then starts up the Internet application 2AP1 (Step #22).

Then, the image forming apparatus 2A performs the following processing, as per the conventional art, through the Internet application 2AP1. If the processing in Step #21 is performed, then the image forming apparatus 2A performs operation for logging onto the server with which the Internet application 2AP1 cooperates based on the second user identifier and the second password written into the setting information file 2FL, or other operation. If the processing in Step #21 is not performed, then the image forming apparatus 2A requests the user Ux to enter the second user identifier and the second password for the Internet application 2AP1. The image forming apparatus 2A then performs the processing for logging onto the server and other operation based on the second user identifier and second password entered by the user.

When both the second user identifier and the second password are entered, or, when at least any one of the second user identifier and the second password is changed, the image forming apparatus 2A sends, to the application information management server 1B, update request data 6KR indicating such a new second user identifier and such a new second password (Step #24).

Upon the receipt of the update request data 6KR, the application information management server 1B adds the application-specific data 6AE for the Internet application 2AP1 to the application identification data 6AD for the user Ux based on the update request data 6KR. Alternatively, upon the receipt of the update request data 6KR, the application information management server 1B updates the current content of the application-specific data 6AE for the Internet application 2AP1 with the content indicated in the update request data 6KR.

According to this embodiment, even if a user operates any of the image forming apparatuses 2, it is possible to free the user from a burden of entering his/her user identifier and password. In other words, according to this embodiment, it is possible to, when a user changes an apparatus to be operated from one to another, manage user identifier and a password more easily than is conventionally possible.

This embodiment is described by taking an example in which the application management software 200 is used in the image forming apparatus 2. Instead of this, however, it is possible to prepare software corresponding to the application management software 200 in the terminal 3 and use such software in the terminal 3.

In this embodiment, the application information management server 1B collectively manages the application identification data 6AD for each user. Instead of this, however, any one of the terminals 3 may collectively manages the application identification data 6AD for each user. Alternatively, if one terminal 3 is assigned to each user, the application identification data 6AD for each user may be distributed to the terminal 3 for the user concerned, and may be managed therein. In such a case, it is preferable that the user account data 6UA contains a URL of the storage location of the application identification data 6AD in the terminal 3 used by the user.

It is to be understood that the configurations of the intranet 5, the resource management server 1A, the application information management server 1B, and the image forming apparatus 2, the constituent elements thereof, the content and order of the processing, the configuration of data, and the like can be appropriately modified without departing from the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A network system comprising:
at least one client; and
a user account management server; wherein
the user account management server includes
a user account saving portion configured to save, thereto, a user identifier and a user password for a cooperative server with which said at least one client works in coordination for specific processing, and
each of said at least one client includes
an application storage portion configured to store, therein, an application for the specific processing,
a reference information storage portion configured to store, therein, reference information to be referred to when the application is executed,
a location information obtaining portion configured to obtain location information indicating a saving location of the user identifier and the user password,
a user account obtaining portion configured to obtain, based on the location information, the user identifier and the user password from the user account management server, and
an update portion configured to update the reference information in such a manner that the user identifier and the user password obtained are indicated.

2. An information processing apparatus for performing specific processing in coordination with a cooperative server, the information processing apparatus comprising:
an application storage portion configured to store, therein, an application for the specific processing;
a reference information storage portion configured to store, therein, reference information to be referred to when the application is executed;
a location information obtaining portion configured to obtain location information indicating a saving location of a user identifier and a user password for the cooperative server;
a user account obtaining portion configured to obtain, based on the location information, the user identifier and the user password from the user account management server; and
an update portion configured to update the reference information in such a manner that the user identifier and the user password obtained are indicated.

3. The information processing apparatus according to claim 2, wherein the user account obtaining portion obtains the user identifier and the user password before the application is initiated.

4. The information processing apparatus according to claim 2, wherein the location information obtaining portion obtains the location information for the user from a local server that is installed in a network in which the information processing apparatus is located and is operable to manage a user account of the user, the location information for the user being obtained when the user logs onto the network through the information processing apparatus.

5. The information processing apparatus according to claim 2, comprising a saving request portion configured to, when the user reenters a user identifier and a user password, request the cooperative server to save the user identifier and the user password reentered to the saving location.

6. The information processing apparatus according to claim 2, comprising an update request portion configured to, when the user changes the user identifier, request the cooperative server to update an existing user identifier with the post-change user identifier, and, when the user changes the user password, request the cooperative server to update an existing user password with the post-change user password.

7. A method for controlling an information processing apparatus for performing specific processing in coordination with a cooperative server, the method comprising:
saving, by a user account management server, a user identifier and a user password for a cooperative server with which the information processing apparatus works in coordination for specific processing;
storing, by the information processing apparatus, an application for the specific processing and reference information to be referred to when the application is executed;
performing, by the information processing apparatus, first processing for obtaining saving location information indicating a saving location of the user identifier and the user password;
performing, by the information processing apparatus, second processing for obtaining, based on the saving location information, the user identifier and the user password from the user account management server; and
performing, by the information processing apparatus, third processing for updating the reference information in such a manner that the user identifier and the user password obtained are indicated.

8. The method according to claim 7, wherein the second processing is executed before the application is initiated.

9. The method according to claim 7, wherein the first processing includes obtaining the saving location information for the user from a local server that is installed in a network in which the information processing apparatus is located and is operable to manage a user account of the user, and the first processing is executed when the user logs onto the network through the information processing apparatus.

10. The method according to claim 7, comprising performing, by the information processing apparatus, fourth processing for, when the user reenters a user identifier and a user password, requesting the cooperative server to save the user identifier and the user password reentered to the saving location.

11. The method according to claim 7, comprising performing, by the information processing apparatus, fifth processing for, when the user changes the user identifier, requesting the cooperative server to update an existing user identifier with the post-change user identifier, and, when the user changes the user password, requesting the cooperative server to update an existing user password with the post-change user password.

12. A non-transitory computer-readable storage medium storing thereon a computer program used in a computer that performs specific processing in coordination with a cooperative server, stores an application for the specific processing, and stores reference information to be referred to when the application is executed, the computer program causing the computer to implement processes comprising:
first processing for obtaining saving location information indicating a saving location of a user identifier and a user password for the cooperative server;
second processing for obtaining, based on the saving location information, the user identifier and the user password from a user account management server; and
third processing for updating the reference information in such a manner that the user identifier and the user password obtained are indicated.

13. The non-transitory computer-readable storage medium according to claim 12, wherein the second processing is executed before the application is initiated.

14. The non-transitory computer-readable storage medium according to claim 12, wherein the first processing includes obtaining the saving location information for the user from a local server that is installed in a network in which the information processing apparatus is located and is operable to manage a user account of the user, and the first processing is executed when the user logs onto the network through the information processing apparatus.

15. The non-transitory computer-readable storage medium according to claim 12, the computer program causing the computer to implement fourth processing for, when the user reenters a user identifier and a user password, requesting the cooperative server to save the user identifier and the user password reentered to the saving location.

16. The non-transitory computer-readable storage medium according to claim 12, the computer program causing the computer to implement fifth processing for, when the user changes the user identifier, requesting the cooperative server to update an existing user identifier with the post-change user identifier, and, when the user changes the user password, requesting the cooperative server to update an existing user password with the post-change user password.
